(19) United States
(12) Patent Application Publication
(10) Pub. No.: US 2012/0321161 A1
(43) Pub. Date: Dec. 20, 2012

(54) IMAGE PROCESSING APPARATUS, IMAGE PROCESSING METHOD, IMAGE PICKUP SYSTEM, AND PROGRAM

(75) Inventors: Ryo Ishikawa, Kawasaki-shi (JP); Yoshio Iizuka, Kyoto-shi (JP); Kiyohide Satoh, Kawasaki-shi (JP); Takaaki Endo, Urayasu-shi (JP)

(73) Assignee: CANON KABUSHIKI KAISHA, Tokyo (JP)

(21) Appl. No.: 13/495,802

(22) Filed: Jun. 13, 2012

(30) Foreign Application Priority Data
Jun. 17, 2011 (JP) 2011-135353

(51) Int. Cl. G06T 15/00; G06K 9/60

(52) U.S. Cl. 382/131; 345/419

(57) ABSTRACT

An image processing apparatus configured to process an ultrasound image includes a three-dimensional image acquisition unit configured to acquire a three-dimensional image obtained by capturing an object in a first deformed state, a tomographic image acquisition unit configured to acquire an ultrasound tomographic image obtained by capturing a particular cross section of the object in a second deformed state, a generation unit configured to generate a curved cross section image corresponding to the ultrasound tomographic image in the first deformed state, based on a conversion rule between the first deformed state and the second deformed state, and a display control unit configured to display the generated curved cross section image and the three-dimensional image in an aligned state on a display unit.

### BACKGROUND

One of techniques used in various fields including a medical field is to take images of an object under examination by using a plurality of image pickup apparatuses that provide different characteristics and features to observe the object from various viewpoints.

For example, in the medical field, a doctor takes an image of a patient using a medical image acquisition apparatus and observes a location of a lesion area and examines a current state or a change in the state of the lesion area by interpreting an obtained medical image. Examples of apparatuses for generating a medical image include a plane X-ray apparatus, an X-ray computed tomography apparatus, a magnetic resonance imaging (MRI) apparatus, an ultrasound imaging apparatus (US), etc. These apparatuses have different/characteristics and features depending on the apparatus type, and a proper combination of a plurality of types of apparatuses is selected depending on a type of part to be examined or a type of a disease. For example, an MRI image of a patient may be taken first, and then an ultrasound image may be taken while referring to the MRI image to obtain information useful for diagnosis in terms of a location, size, or the like of a lesion area.

In diagnosis, it is effective to observe a part of an object in an ultrasound image and a corresponding part of the object in a three-dimensional MRI image. To this end, it is required to indicate, in an easily understandable manner, which part of the object is captured by each of the two images and how these two images correspond to each other.

However, in a case where a change in shape (deformation) of the object occurs between the ultrasound image and the MRI image, if the captured images are directly displayed, it may be difficult for an examiner to recognize a complicated spatial relationship between the corresponding parts captured in the two images. In a technique disclosed in a technical paper (T. Carter, C. Tanner, N. B. Newman, D. Barrattand, and D. Hawkes, “MR Navigated Breast Surgery: Method and Initial Clinical Experience” (MICCAI 2008, Part II, LNCS5242, pp. 356-363, 2008)), a difference in shape of an object under examination between two images is estimated and a three-dimensional MRI image is modified in terms of the shape to provide a correct correspondence between the two images. However, modifying the shape of the three-dimensional image may result in a difficulty in observing the three-dimensional image. In view of the above, an embodiment of the present invention provides a technique to allow a user to easily understand which part or location of a three-dimensional image is captured by a tomographic image.

### SUMMARY

According to some embodiments of the invention, an image processing apparatus configured to process an ultrasound image includes a three-dimensional image acquisition unit configured to acquire a three-dimensional image obtained by capturing an object that is in a first deformed state, a tomographic image acquisition unit configured to acquire an ultrasound tomographic image obtained by capturing a particular cross section of the object that is in a second deformed state, a generation unit configured to generate a curved cross section image corresponding to the ultrasound tomographic image in the first deformed state, based on a conversion rule between the first deformed state and the second deformed state, and a display control unit configured to display the generated curved cross section image and the three-dimensional image in an aligned state on a display unit.

Embodiments of the present invention will become apparent from the following description of exemplary embodiments with reference to the attached drawings.

### BRIEF DESCRIPTION OF THE DRAWINGS

FIG. 1 is a diagram illustrating a functional configuration of an image pickup system according to a first embodiment.

FIG. 2 is a diagram illustrating an apparatus configuration of the image pickup system according to the first embodiment.

FIG. 3 is a flow chart illustrating a processing procedure performed by an image processing apparatus according to the first embodiment.

FIG. 4 is a diagram illustrating an MRI image according to the first embodiment.

FIG. 5 is a diagram illustrating an ultrasound image according to the first embodiment.

FIGS. 6A to 6D are diagrams illustrating a process performed in step S307 of FIG. 3 according to the first embodiment.

FIG. 7 is a diagram illustrating a functional configuration of an image pickup system according to an another embodiment.

FIG. 8 is a flow chart illustrating a processing procedure performed by an image processing apparatus according to another embodiment.

FIG. 9 is a diagram illustrating a process performed in step S807 according to another embodiment.

FIG. 10 is a diagram illustrating a functional configuration of an image pickup system according to an alternative embodiment.

### DESCRIPTION OF THE EMBODIMENTS

According to an embodiment, an image processing apparatus acquires a three-dimensional MRI image and a two-dimensional ultrasound image of an object under examination. The object under examination may have deformation, and the three-dimensional MRI image and the two-dimensional ultrasound image are respectively captured when the object are in different deformed states. A curved cross section in the three-dimensional MRI image is then calculated such that the curved cross section corresponds to the two-dimensional cross section in which the ultrasound image was captured, and an image is generated which is obtained by projecting the ultrasound image onto the curved cross section. This generated image is referred to as a shape-modified ultrasound image. Furthermore, a cross sectional image taken at the above-described curved cross section in the MRI image is generated. This generated image is referred to as a corresponding-cross-section MRI image (curved cross section image). The resultant corresponding-cross-section MRI image is displayed together with the shape-modified ultrasound image. In the present embodiment, it is assumed, by way of example, that the object under examination is a breast of a human body, and it is also assumed that there is a difference in a direction in which gravitation acts on the object under examination between a time of taking the MRI image and a time of taking the ultrasound image, and thus deformation of the object under examination occurs. More specifically, it is assumed that the MRI image is captured in a state (first deformed state) in which a patient is in a prone position, while the ultrasound image is captured in a state (second deformed state) in which the patient is in a supine position. Hereinafter, for simplicity of description, deformed states of the object under examination are denoted as follows. That is, a “before-deformation state” denotes a state (a first deformed state) in which the object under examination is in a prone position for being subjected to capturing an MRI image, and an “after-deformation state” denotes a state (a second deformed state) in which the object under examination is in a supine position for being subjected to capturing an ultrasound image.

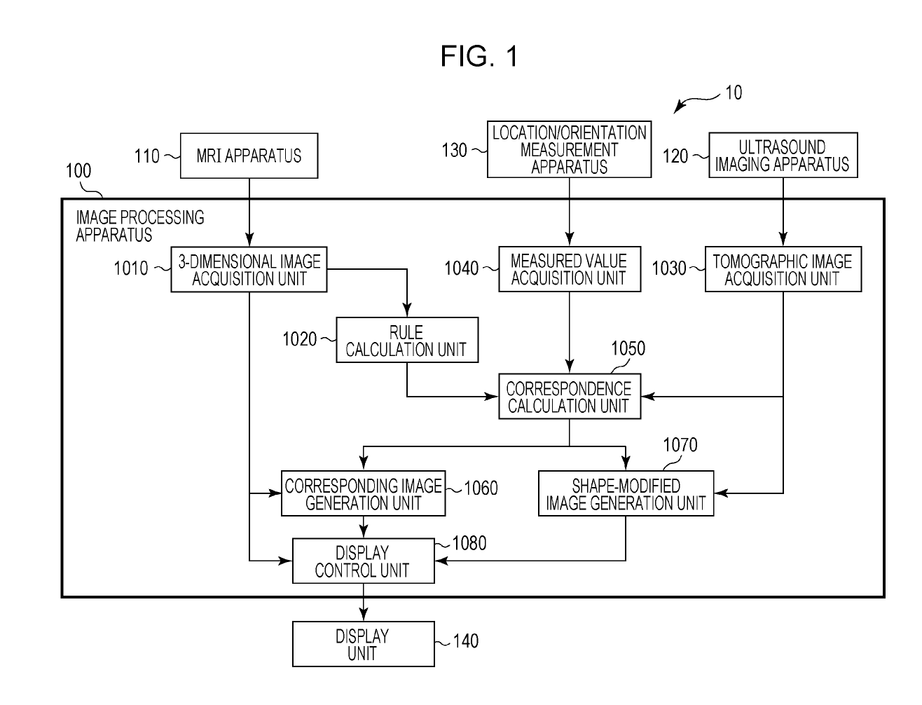

Referring to FIG. 1, a configuration of an image pickup system 10 according to the present embodiment is described.

An MRI apparatus 110 acquires an MRI image obtained by capturing an MRI image of a particular three-dimensional region of an object under examination. Note that the MRI image is captured under the condition that the object under examination is in the before-deformation state.

An ultrasound imaging apparatus 120 acquires a two-dimensional ultrasound tomographic image of an inner region of the object under examination by putting an ultrasonic probe (not shown) in contact with the object under examination. More specifically, the ultrasonic probe transmits ultrasound and the two-dimensional ultrasound tomographic image is produced based on reflected ultrasound. In the present embodiment, a two-dimensional B-mode ultrasound image is acquired for a particular two-dimensional region of the object under examination.

A location/orientation measurement apparatus 130 measures the location and the orientation of the ultrasonic probe (not shown) of the ultrasound imaging apparatus 120. For example, the location/orientation measurement apparatus 130 may be configured using a FASTRAK sensor available from Polhemus, which is a company of the USA. The location/orientation of the ultrasonic probe is measured with reference to a sensor coordinate system (defined as a reference coordinate system by the location/orientation measurement apparatus 130). The location/orientation measurement apparatus 130 may be configured in an arbitrary manner as long as the location/orientation of the ultrasonic probe can be measured.

The image processing apparatus 100 is connected to the MRI apparatus 110, the ultrasound imaging apparatus 120, the location/orientation measurement apparatus 130, and the display unit 140.

A three-dimensional image acquisition unit 1010 acquires an MRI image of an object under examination captured by the MRI apparatus 110 and outputs the acquired MRI image to a rule calculation unit 1020, a corresponding-image generation unit 1060, and a display control unit 1080.

Based on the MRI image acquired by the three-dimensional image acquisition unit 1010, the rule calculation unit 1020 determines a conversion rule indicating a rule of estimating the deformation of the object under examination. The determined conversion rule is output to a correspondence calculation unit 1050.

A tomographic image acquisition unit (tomographic image acquisition unit) 1030 acquires an ultrasound image of the object under examination captured by the ultrasound imaging apparatus 120 and outputs the acquired ultrasound image to the correspondence calculation unit 1050 and a shape-modified image generation unit 1070.

A measured-value acquisition unit 1040 acquires a measured value associated with a location/orientation of the ultrasonic probe from the location/orientation measurement apparatus 130 and outputs the acquired measured value to the correspondence calculation unit 1050.

The correspondence calculation unit 1050 performs a process, described below, based on the location/orientation of the ultrasonic probe acquired by the measured-value acquisition unit 1040, the estimated deformation value calculated by the rule calculation unit 1020, and the ultrasound image acquired by the tomographic image acquisition unit 1030. That is, based on the estimated deformation value, the correspondence calculation unit 1050 calculates a corresponding MRI cross section and a corresponding MRI region, in the MRI image, that respectively correspond to the image-capturing cross section and the image-capturing region captured by the ultrasound imaging apparatus 120. The correspondence calculation unit 1050 outputs the obtained information associated with the corresponding MRI cross section and the corresponding MRI region to the corresponding-image generation unit 1060 and the shape-modified image generation unit 1070.

The corresponding-image generation unit 1060 (first generation unit) generates a cross-sectional image (corresponding-cross-section MRI image) of the MRI image taken in the corresponding MRI cross section calculated by the correspondence calculation unit 1050 and outputs the generated cross-sectional image to the display control unit 1080.

The shape-modified image generation unit 1070 (second generation unit) generates a shape-modified ultrasound image, which is obtained by projecting the ultrasound image acquired by the tomographic image acquisition unit 1030 onto the corresponding MRI region calculated by the correspondence calculation unit 1050, and outputs the generated shape-modified ultrasound image to the display control unit 1080.

The display control unit 1080 controls an operation of displaying the generated image on the display unit 140. More specifically, the display control unit 1080 generates data of image to be displayed (hereinafter referred to simply as display image data) based on the MRI image acquired by the three-dimensional image acquisition unit 1010, the corresponding-cross-section MRI image generated by the corresponding-image generation unit 1060, and the shape-modified ultrasound image generated by the shape-modified image generation unit 1070, and the display control unit 1080 outputs the generated display image data to the display unit 140.

The display unit 140 displays an image according to the display image data generated by the display control unit 1080.

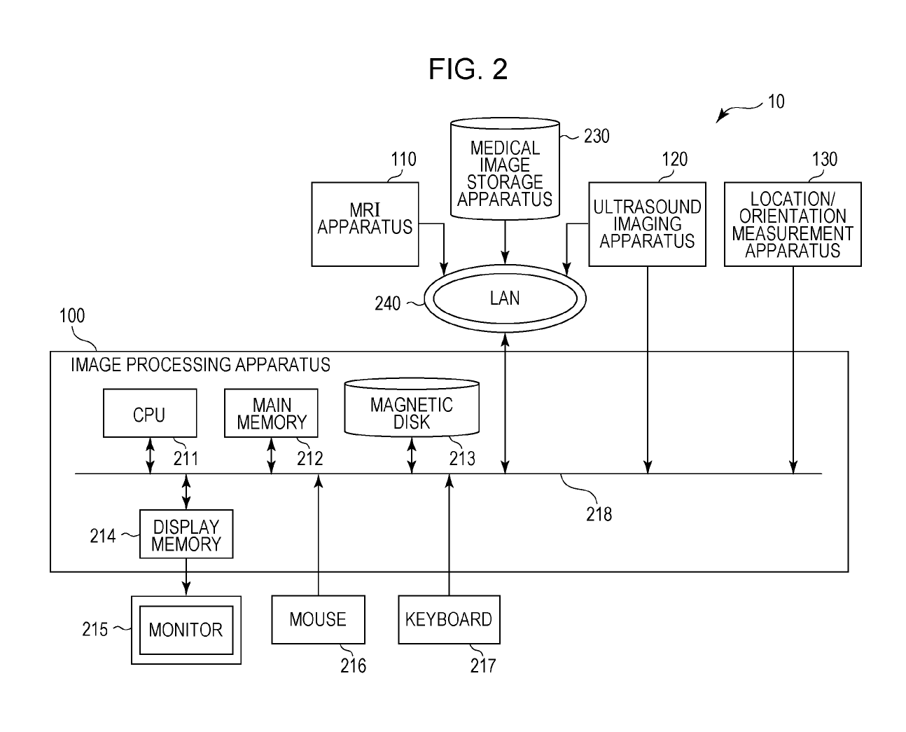

FIG. 2 illustrates a hardware configuration of the image processing apparatus 100 according to an embodiment. The image pickup system 10 according to the present embodiment includes the image processing apparatus 100, the MRI apparatus 110, a medical image storage apparatus 230, a local area network (LAN) 240, the ultrasound imaging apparatus 120, and the location/orientation measurement apparatus 130.

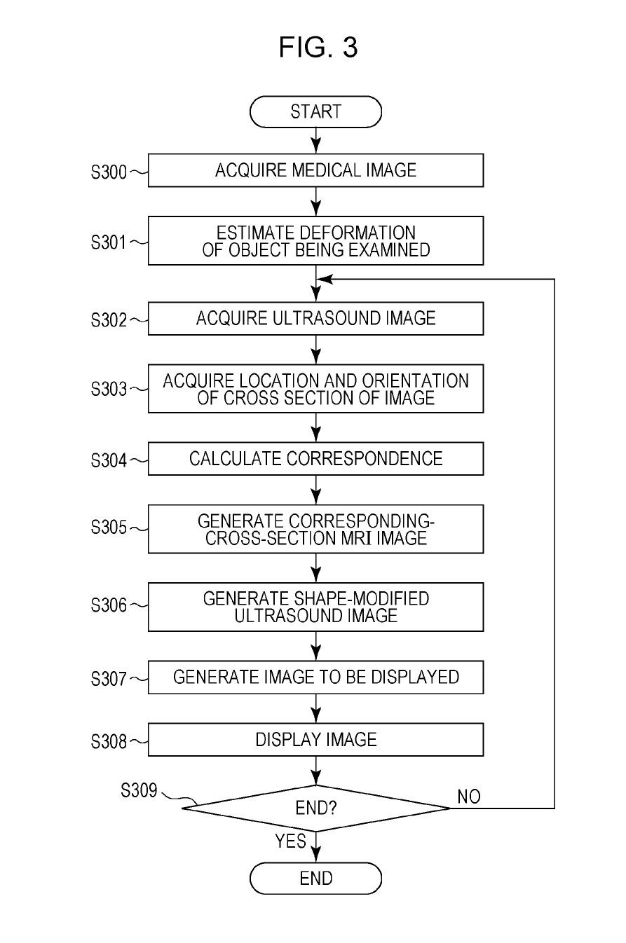

The image processing apparatus 100 may be realized, for example, on a personal computer (PC) or the like. The image processing apparatus 100 includes a central processing unit (CPU) 211, a main memory 212, a magnetic disk 213, and a display memory 214, and is connected to a monitor 215, a mouse 216, and a keyboard 217. The CPU 211 mainly controls operations of various parts of the image processing apparatus 100. The main memory 212 stores a control program for executing a process shown in FIG. 3 and provides a work area used by the CPU 211 in the execution of the program.

The magnetic disk 213 stores an operating system (OS) and various application software programs including device drivers for controlling peripheral devices, a program for an alignment process described later, etc.

The display memory 214 temporarily stores display image data for use in displaying an image on the monitor 215. The monitor 215 may be, for example, a CRT monitor, a liquid crystal monitor, or the like which displays the image according to the data supplied from the display memory 214. The mouse 216 and the keyboard 217 are used by a user to input pointing data, character data, commands, etc. The units/elements described above are connected to each other via a common bus 218 such that they are allowed to communicate to each other.

In the present embodiment, the image processing apparatus 100 is capable of reading medical image data or the like from the medical image storage apparatus 230 via the LAN 240 thereby acquiring the medical image data or the like. The image processing apparatus 100 may be adapted to directly acquire medical image data or the like from the MRI apparatus 110 via the LAN 240. Alternatively or additionally, the image processing apparatus 100 may be connected to an external storage device such as a USB memory such that the image processing apparatus 100 is capable of reading medical image data or the like from the external storage device. Furthermore, such an external storage device may be used to store a result of a process performed by the present system. An ultrasound image captured by the ultrasound imaging apparatus 120 may be stored in the medical image storage apparatus 230 such that the image processing apparatus 100 is allowed to read the ultrasound image from the medical image storage apparatus 230 to acquire the ultrasound image.

The CPU 211 executes the program stored in the main memory 212 whereby the hardware of the image processing apparatus 100 cooperates with the software to achieve the functions of various units shown in FIG. 1. Part or all units shown in FIG. 1 may be realized by hardware, and the program may set parameters of the units and control a processing procedure performed by the units.

Next, referring to a flow chart shown in FIG. 3, an overall operation of the image processing apparatus 100 is described below. Various functions in the present embodiment are realized by executing programs stored in the main memory 212 by the CPU 211.

### Step 300: Acquiring Medical Image

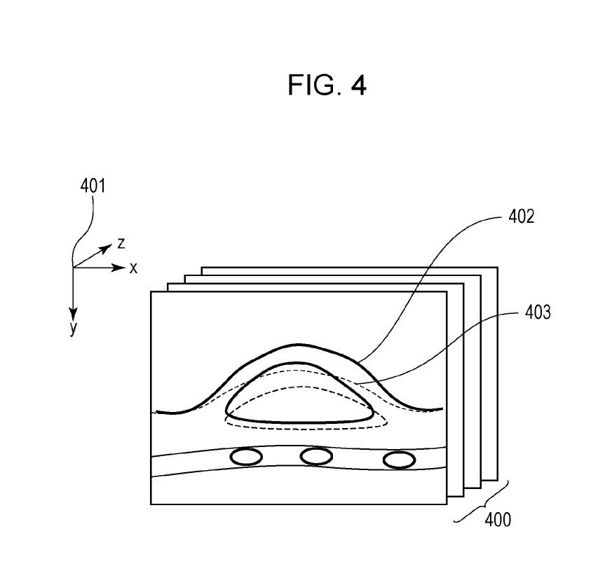

In step S300, the three-dimensional image acquisition unit 1010 acquires a three-dimensional image of an object under examination captured by the MRI apparatus 110. FIG. 4 illustrates an example of a three-dimensional image. An MRI image 400 includes a plurality of frames of cross-sectional images in a three-dimensional space defined by an MRI image coordinate system 401. A pair of three-dimensional coordinates of each pixel and a luminance value of the pixel is acquired for all pixels on each cross-sectional image as information of the MRI image 400. A set of coordinates for all pixels of MRI image 400 is denoted by R_{MRI}.

### Step S301: Estimating Deformation of Object Under Examination

In step S301, based on the MRI image acquired by the three-dimensional image acquisition unit 1010, the rule calculation unit 1020 determines a conversion rule indicating a rule of estimating the deformation of the object under examination. The conversion rule associated with the deformation of the object under examination is described as information indicating the deformation of the object under examination with respect to the state before deformation. For example, the conversion rule may be expressed by a function f_{deform}(x, y, z) given below in Equation 1.

$$( \begin{matrix}{x}^{′} \\ {y}^{′} \\ {z}^{′}\end{matrix} ) = {f}_{deform} ( x , y , z ) \qquad ( 1 )$$

where (x, y, z) is a set of coordinates indicating a location in the MRI image coordinate system, and (x′, y′, z′) is a set of coordinates in the MRI image coordinate system indicating a location of a point on the object under examination after deformation corresponding to a point indicated by the coordinates before deformation. The function f_{deform} may be a continuous function expressed, for example, by a polynomial of (x, y, z), or may be a discrete function. The function f_{deform} may be determined using a known deformation simulation technique based on a finite element method such as that described in the technical paper cited above (T. Carter, C. Tanner, N. B. Newman, D. Barrattand, D. Hawkes, “MR Navigated Breast Surgery: Method and Initial Clinical Experience” (MICCAI 2008, Part II, LNCS5242, pp. 356-363, 2008)), or the like. FIG. 4 illustrates an example of an estimation result of deformation. In this figure, a reference numeral 402 denotes an MRI image representing a shape of an object under examination in a before-deformation state, and a reference numeral 403 denotes an estimation result of a shape of the object under examination whose shape has been changed due to gravitation with respect to the shape before deformation. In the MRI image coordinate system 401, the relationship between the shape of the object under examination 402 before deformation and the estimated shape of the object after deformation (i.e., the estimation result 403) is described by the function f_{deform} given by Equation (1). That is, when coordinates of an arbitrary point on the object under examination 402 before deformation are given as arguments on the right side of the function f_{deform} represented in Equation (1), the estimation result 403, i.e., coordinates of the object under examination in the state after deformation is given by the left side of the function f_{deform} for a point corresponding to the above-described point in the state before deformation.

### Step S302: Acquiring Ultrasound Image

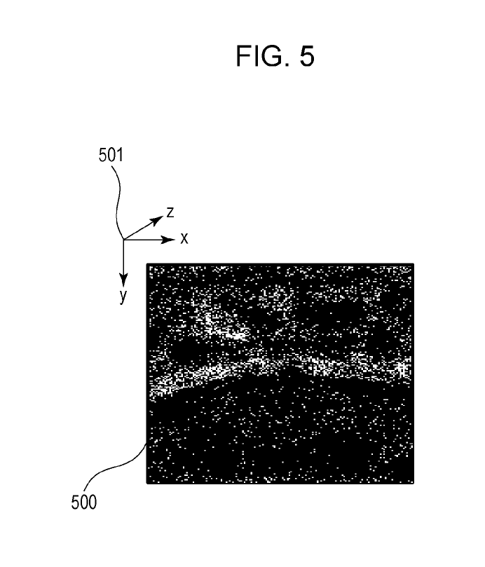

In step S302, the tomographic image acquisition unit 1030 acquires an ultrasound image of the object under examination captured by the ultrasound imaging apparatus 120. The ultrasound image may be a Doppler ultrasound image, an ultrasound elastography image, or the like. In the present embodiment, it is assumed, by way of example, that the acquired ultrasound image is a two-dimensional B-mode tomographic image of an object under examination. FIG. 5 illustrates an example of an ultrasound image. An ultrasound image 500 is acquired as sets of a luminance value and coordinates in an ultrasound image coordinate system 501. The ultrasound image coordinate system 501 is defined such that an x-y plane represents a plane in which the ultrasound image lies and a z-axis is taken to be perpendicular to the x-y plane. Thus, in the present embodiment, pixels of the ultrasound image 500 are located only in the plane with z=0. Hereinafter, the plane with z=0 is denoted as an ultrasound image plane S_{US} in the ultrasound image coordinate system 501. A finite plane region that is included in the ultrasound image plane S_{US} and that includes the ultrasound image 500 is denoted as an ultrasound image region R_{US}. A set of luminance values of pixels of the ultrasound image 500 is denoted by I_{US}. Each element of I_{US} is stored in association with a corresponding element of R_{US}. The ultrasound image plane S_{US} and the ultrasound image region R_{US} are expressed with reference to the ultrasound image coordinate system 501.

### Step S303: Acquiring Location/Orientation of Image-Capturing Cross Section

In step S303, based on the result of the measurement performed by the location/orientation measurement apparatus 130, the measured-value acquisition unit 1040 acquires the relationship between the location/orientation of the object under examination in the ultrasound image coordinate system 501 and that in the MRI image coordinate system 401. The location/orientation measurement apparatus 130 has its own reference coordinate system, and outputs a measured value of the location/orientation in this coordinate system. In the present embodiment, the measured-value acquisition unit 1040 acquires the location/orientation of the ultrasound image coordinate system 501 expressed in the MRI image coordinate system 401 by converting the measured value using a known technique. More specifically, a 4-row and 4-column rigid body transformation matrix is acquired for use in transforming coordinates in the ultrasound image coordinate system 501 into coordinates in the MRI image coordinate system 401.

### Step S304: Calculating Correspondence

In S304, the correspondence calculation unit 1050 calculates a corresponding MRI region and a corresponding MRI cross section in the MRI image 400 captured for the object under examination before deformation such that the corresponding MRI cross section and the corresponding MRI region correspond respectively to the ultrasound image plane S_{US} and the ultrasound image region R_{US} of the ultrasound image acquired in step S302. The corresponding MRI region is a region in the MRI image 400 corresponding to the region of the object under examination indicated by the ultrasound image region R_{US}. The corresponding MRI cross section is a plane in the MRI image corresponding to the ultrasound image plane S_{US}. Deformation may occur in a period between the time of taking the ultrasound image 500 and the time of taking the MRI image 400, and thus the ultrasound image region R_{US} does not necessarily coincide with the corresponding MRI region in the MRI image coordinate system 401. Similarly, the ultrasound image plane S_{US} does not necessarily coincide with the corresponding MRI cross section. Thus, the correspondence calculation unit 1050 calculates the corresponding MRI cross section and the corresponding MRI region based on the estimated deformation value of the object under examination acquired in step S301. The process in step S304 performed by the correspondence calculation unit 1050 is described in further detail below.

The correspondence calculation unit 1050 transforms the ultrasound image plane S_{US} (i.e., the plane with z=0) acquired in step S302 into a plane S′_{US} in the MRI image coordinate system 401 by using the rigid body transformation matrix acquired in step S303. More specifically, an inverse matrix T of the rigid body transformation matrix acquired in step S303 is determined, and the plane S′_{US} is determined such that (T₃₁)x+(T₃₂)y+(T₃₃)z+(T₃₄)=0 for coordinates (x, y, z) in the MRI image coordinate system 401 where Tᵢⱼ is an element in an i-th row and j-th column of the matrix T. Furthermore, the ultrasound image region R_{US} is transformed into an ultrasound image region R′_{US} in the MRI image coordinate system 401 by multiplying coordinates of each element in the ultrasound image region R_{US} by the rigid body transformation matrix acquired in step S303.

Next, using Equation (1) described above, a set of coordinates R_{MRI}_{_{—}}_{D} after deformation is calculated for coordinates R_{MRI} of each pixel of the MRI image 400 acquired in step S301. Each element of the set of coordinates R_{MRI}_{_{—}}_{D} after deformation is stored in connection with corresponding element of the coordinates R_{MRI} before deformation. Thereafter, for each coordinate point R_{MRI}_{_{—}}_{D} after deformation, the distance to each coordinate point in the ultrasound image region R′_{US} is calculated and a coordinate point with the smallest distance (i.e., a closest point) is determined. Furthermore, a subset of R_{MRI}_{_{—}}_{D} in which the distance is within a predetermined range is determined (the resultant subset is denoted as R_{MRI}_{_{—}}_{D}_{_{—}}_{NEAREST}), and a set of coordinate points (R_{MRI}_{_{—}}_{NEAREST}) before deformation corresponding to the subset R_{MRI}_{_{—}}_{D}_{_{—}}_{NEAREST} is determined. A closest element in R′_{US} with respect to each element of R_{MRI}_{_{—}}_{D}_{_{—}}_{NEAREST} is determined thereby determining a set of such closest elements R′_{US}_{_{—}}_{NEAREST}. That is, elements of R_{MRI}_{_{—}}_{NEAREST} and elements of R_{MRI}_{_{—}}_{D}_{_{—}}_{NEAREST} have a relationship expressed by Equation (1), and the distance from any element of R_{MRI}_{_{—}}_{D}_{_{—}}_{NEAREST} to a corresponding element of R′_{US}_{_{—}}_{NEAREST} is within the above-described range. In the present embodiment, the corresponding MRI region calculated by the correspondence calculation unit 1050 is R_{MRI}_{_{—}}_{NEAREST}, and R_{MRI}_{_{—}}_{NEAREST} is stored together with R_{MRI}_{_{—}}_{D}_{_{—}}_{NEAREST} and R′_{US}_{_{—}}_{NEAREST} as associated information. Note that these sets of coordinate are stored such that elements thereof are related to each other.

Similarly, among the set of coordinates after deformation R_{MRI}_{_{—}}_{D} calculated in the above-described manner, elements are determined that are in a predetermined range in terms of the distance to the ultrasound image plane S′_{US}, and resultant elements are described as a set of coordinates S_{MRI}_{_{—}}_{D}. Furthermore, a set of coordinates before deformation corresponding to elements of S_{MRI}_{_{—}}_{D} is determined. The result is stored as a corresponding MRI cross section.

The corresponding MRI region and the corresponding MRI cross section may be stored as sets of coordinates as in the example described above, or may be expressed by implicit functions using polynomials or the like and the implicit functions may be stored. This may be implemented using a known technique, and thus a further detailed description thereof is omitted.

The method of determining the corresponding MRI region and the corresponding MRI cross section is not limited to that described above. For example, an inverse function of the function f_{deform} shown in Equation (1) may be determined in advance, and a set of coordinates constituting the ultrasound image region R′_{US} and the ultrasound image plane S′_{US} including the ultrasound image region R′_{US} may be determined using the inverse function thereby determining the corresponding MRI region and the corresponding MRI cross section.

In the MRI image coordinate system 401, the ultrasound image region R′_{US} and the ultrasound image plane S′_{US} lie in a plane. However, the corresponding MRI region and the corresponding MRI cross section, which are calculated based on the estimation of the deformation of the object under examination, do not necessarily lie in a plane. For example, in a case where the deformation estimated in step S301 is nonlinear in a space, the corresponding MRI region and the corresponding MRI cross section are a curved surface or the like.

### Step S305: Generating Corresponding-Cross-Section MRI Image

In step S305, the corresponding-image generation unit 1060 generates a corresponding-cross-section MRI image based on the corresponding MRI cross section obtained in step S304. More specifically, the corresponding-cross-section MRI image is generated as a pair of a set of coordinates S_{MRI} constituting the corresponding MRI cross section acquired in step S304 and a set of luminance values of MRI image 400 corresponding to the coordinates of the respective elements.

### Step S306: Generating Shape-Modified Ultrasound Image

In step S306, from the ultrasound image 500 captured for the object under examination after deformation, the shape-modified image generation unit 1070 generates a shape-modified ultrasound image of a region corresponding to the region of the object under examination before deformation. The shape-modified ultrasound image generated in this step is given as a pair of coordinates of each pixel of the image and a luminance value as with the corresponding-cross-section MRI image generated in step S305. As for the coordinates, those in the corresponding MRI region (R_{MRI}_{_{—}}_{NEAREST}) acquired in step S304 may be used. The luminance values are given by those of the ultrasound image 500 at respective locations given by elements of the set R′_{US}_{_{—}}_{NEAREST} of the ultrasound image closest to the elements of the set R_{MRI}_{_{—}}_{NEAREST} stored as the associated information in step S304. That is, the shape-modified ultrasound image is an image obtained by projecting the ultrasound image onto the region indicated by the corresponding MRI region in the MRI image coordinate system 401, based on the deformation estimated in step S301.

Step S307: Generating Image to be Displayed

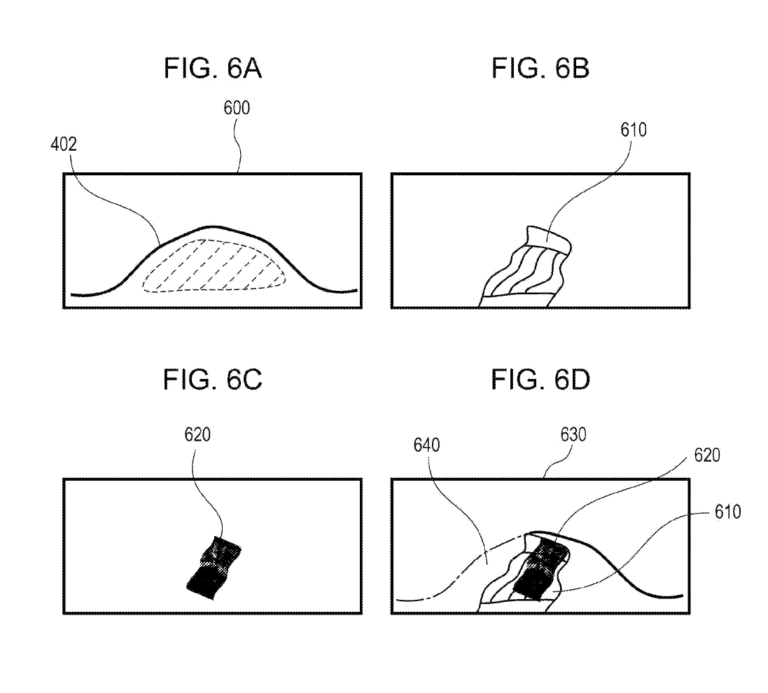

In step S307, the display control unit 1080 generates a display image (an image to be displayed) based on the MRI image acquired in step S300, the corresponding-cross-section MRI image generated in step S305, and the shape-modified ultrasound image generated in step S306. There are many methods of generating the display image. For example, a two-dimensional image may be generated by performing volume-rendering on the MRI image, and the corresponding-cross-section MRI image and the shape-modified ultrasound image may be superimposed on the two-dimensional image as described in detail below with reference to FIGS. 6A to 6D. FIG. 6A illustrates a rendered image 600 generated by performing volume-rendering on the MRI image acquired in step S300. This rendered image 600 is a two-dimensional image generated by rendering the MRI image of the object under examination before deformation such that the rendered result represents an image viewed from an arbitrarily determined virtual viewpoint. FIG. 6B illustrates an image obtained by rendering the corresponding-cross-section MRI image generated in step S305 such that the rendered result represents a view seen from a similar virtual viewpoint. FIG. 6C illustrates an image obtained by rendering the shape-modified ultrasound image generated in step S306 such that the rendered result represents a view seen from a similar virtual viewpoint. As shown in FIG. 6D, the display control unit 1080 superimposes the corresponding-cross-section MRI image 610 on the rendered image 600 and further superimposes the shape-modified ultrasound image 620 thereby obtaining the display image 630 as a result. In generating the rendered image 600, a region 640 closer to the viewpoint than the corresponding MRI cross section of the MRI image may be reduced in opacity or may not be subjected to the rendering process to obtain a display image that allows it to easily understand a positional relationship among the object under examination 402 before deformation, the corresponding-cross-section MRI image 610, and the shape-modified ultrasound image 620.

### Step S308: Displaying Image

In step S308, the display unit 140 transmits the display image generated in step S307 to the display memory 214 thereby performing a process of displaying the image on the monitor 215.

Step S309: Determine as to Ending

In step S309, the image processing apparatus 100 determines whether the whole process is to be ended. For example, when an operator inputs an end command by clicking, with the mouse 216, an end button displayed on the monitor 215, the image processing apparatus 100 determines that the whole process is to be ended. In a case where it is determined that the whole process is to be ended, the whole process of the image processing apparatus 100 is ended. On the other hand, in a case where it is not determined that the whole process is to be ended, the processing flow returns to step S302 to again perform steps S302 to S308 on a newly acquired ultrasound image 500 and a result of the location/orientation measurement.

The process performed in the image processing apparatus 100 has been described above.

As described above, in the image pickup system 10 according to the present embodiment, when an ultrasound image of an object under examination after deformation is captured, an image can be displayed in such a manner that it is possible to easily understand a positional relationship between a region of the ultrasound image and a corresponding region of an MRI image of the object under examination in the before-deformation state. It is also possible to observe, under a proper condition, an image of the corresponding region of the MRI image corresponding to the image-capturing region of the ultrasound image.

Furthermore, it is possible to provide a mechanism of displaying an image obtained by projecting a cross-sectional image of an object under examination acquired in capturing an ultrasound image onto a corresponding region in a three-dimensional image. Therefore, it is possible to clearly present information to a medical doctor in terms of where various parts of the ultrasound image are located in the three-dimensional image of the object under examination in a different deformed state.

It is possible to provide a mechanism of displaying an image of a corresponding region of a three-dimensional image corresponding to a cross-section region of an ultrasound image being captured for an object under examination. Therefore, it is possible to present to a medical doctor an image clearly indicating a region corresponding to a region of the three-dimensional image of the ultrasound image being captured for the object under examination in a different deformed state.

### Modified Example 1-1

### Superimposing No MRI Cross-Sectional Image

In the embodiment described above, it is assumed by way of example that an corresponding-cross-section MRI image is generated and superimposed on a volume-rendered image of an MRI image in a displayed image. However, the manner of displaying the image is not limited to this example. For example, the process in step S305 may be omitted, and the process in step S307 may be performed such that a volume-rendered image is generated for an image obtained by clipping the MRI image at an corresponding MRI cross section calculated in step S304, and on this result, a shape-modified ultrasound image may be superimposed. In this case, it is not necessary to perform the process of generating a corresponding-cross-section MRI image and the process of superimposing the generating corresponding-cross-section MRI image, and thus simplification of the process and an increase in processing speed can be achieved.

Furthermore, in the embodiment described above, it is assumed by way of example that an image obtained by projecting luminance values of the ultrasound image 500 onto the corresponding MRI region R_{MRI}_{_{—}}_{NEAREST} is employed as the shape-modified ultrasound image. Alternatively, for example, the shape-modified ultrasound image may be a frame border corresponding to a boundary of the image-capturing region R′_{US} of the ultrasound image 500 in the MRI image in the after-deformation state. More specifically, a subset R″_{US} of R′_{US} may be determined such that R″_{US} is constituted by coordinates corresponding to the boundary of the image-capturing region of the ultrasound image 500, and a following process may be performed. That is, for each element of the set of coordinates R_{MRI}_{_{—}}_{D} in the after-deformation state, distances to respective elements of the set of coordinates R″_{US} are calculated, and coordinates of the element having a least distance (i.e., a closest element) are determined. Furthermore, a subset R″_{MRI}_{_{—}}_{D}_{_{—}}_{NEAREST} of R_{MRI}_{_{—}}_{D} is determined such that any element of the subset R″_{MRI}_{_{—}}_{D}_{_{—}}_{NEAREST} has a distance within a predetermined range, and a set (R″_{MRI}_{_{—}}_{NEAREST}) of elements in the before-deformation state that corresponds to this subset R″_{MRI}_{_{—}}_{D}_{_{—}}_{NEAREST} is determined. A frame border defined by R″_{MRI}_{_{—}}_{NEAREST} is employed as the shape-modified ultrasound image. In this case, in the process of calculating the corresponding MRI region, it is sufficient to perform only the process associated with the frame border, and thus simplification of the operation and an increase in operation speed can be achieved.

### Modified Example 1-2

### Rendering Other than Volume-Rendering

In the embodiment described above, it is assumed by way of example that the method of generating the to-be-displayed image is based on the image obtained by performing the volume-rendering on the MRI image. However, the method used in the embodiment is not limited to this example. For example, an internal tissue structure such as a skin, a breast muscle, a mammary gland, or the like of an object under examination may be extracted from an MRI image of the object, and an image may be produced by performing a surface-rendering based on a contour of the extracted internal tissue structure.

In another embodiment described below, instead of displaying an MRI cross section corresponding to a shape-modified ultrasound image, an arbitrary one of cross-sectional images constituting a three-dimensional MRI image is set as a cross-sectional image of interest, and a shape-modified ultrasound image described above in the embodiment is displayed together with the cross-sectional image of interest.

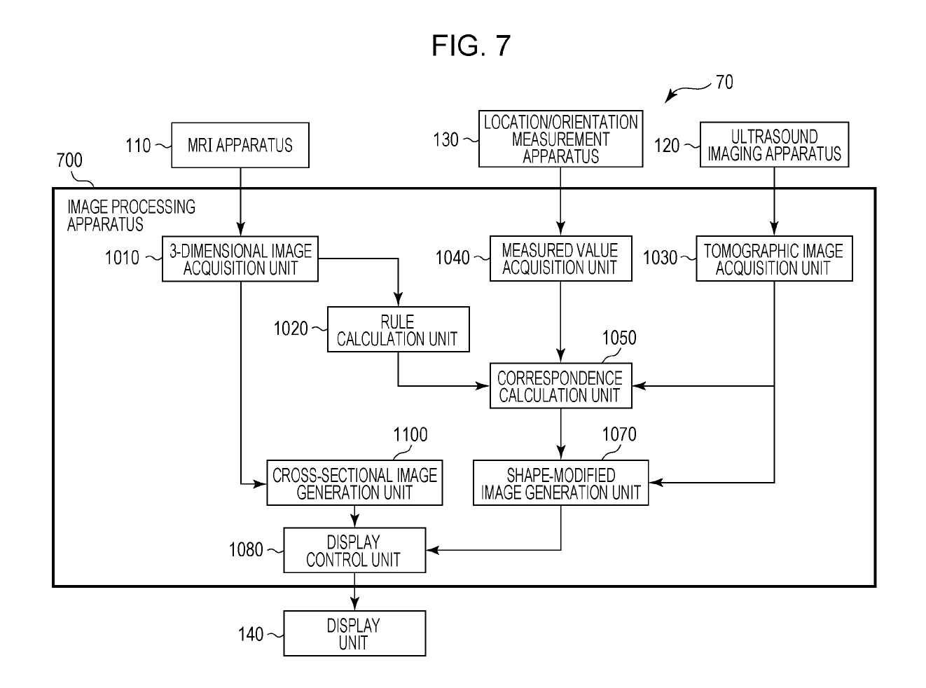

FIG. 7 illustrates a configuration of an image pickup system 70 according to another embodiment. Units/elements similar to those of the image pickup system 10 according to the embodiment described above are denoted by similar reference numerals, and a further description thereof is omitted.

A cross-sectional image generation unit 1100 generates a cross-sectional image of interest from a three-dimensional MRI image acquired by a three-dimensional image acquisition unit 1010, based on a command/information or the like input by a user. The generated cross-sectional image of interest is transmitted to a display control unit 1080.

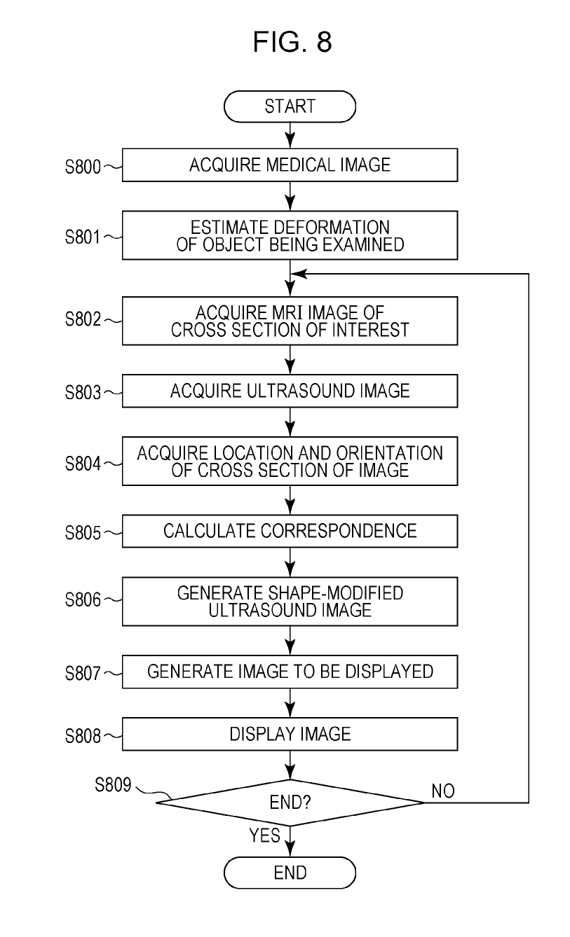

Next, referring to a flow chart shown in FIG. 8, an overall operation performed by the image processing apparatus 700 according to the present embodiment is described in detail below. Steps S800 and S801 are similar to steps S300 and S301 performed by the image processing apparatus 100 according to the embodiment described above with reference to FIG. 3, and thus a further description thereof is omitted. Furthermore, steps from S803 to S806 are similar to steps from S302 to S306, and steps S808 and S809 are similar to steps S308 and S309, and thus a further description thereof is also omitted. The process in step S802 and the process in step S807 are described below.

### Step S802: Acquiring MRI Cross-Sectional Image of Interest

In step S802, the cross-sectional image generation unit 1100 selects a cross section of interest representing a lesion area or the like from the MRI image acquired in step S800 based on a command/information or the like input by a user, and the cross-sectional image generation unit 1100 acquires the image of selected cross section of interest as an MRI cross-sectional image of interest. The MRI cross-sectional image of interest is a two-dimensional image that is acquired as luminance values of respective pixels constituting the image in connection with coordinates of the respective pixels. The coordinates are described with reference to an MRI image coordinate system associated with the MRI image acquired in step S800.

### Step S807: Generating Display Image

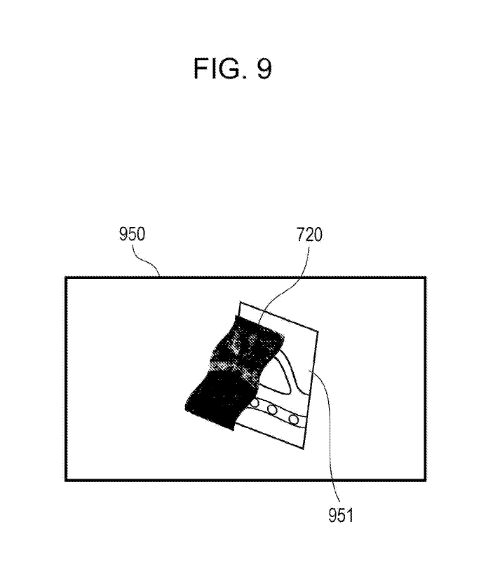

In step S807, the display control unit 1080 generates a display image based on an MRI cross-sectional image of interest generated in step S802 and a shape-modified ultrasound image generated in step S806. FIG. 9 illustrates a specific example of this process. In FIG. 9, reference numeral 950 denotes an example of a display image generated by the display control unit 1080. The display image 950 includes a shape-modified ultrasound image 720 and an MRI cross-sectional image of interest 951. Each of pixels constituting these images has its own coordinates in the MRI image coordinate system and luminance value. Pixels each having a particular luminance value are placed at locations indicated by coordinates. This process is performed for each of the images described above. Furthermore, rendering is performed to obtain an image representing a view seen from a virtual viewpoint arbitrarily set in the MRI image coordinate system. As a result, the display image 950 is obtained.

The process performed in the image processing apparatus 700 has been described above.

As described above, in the image pickup system 70 according to the present embodiment, a MRI cross-sectional image of interest specified by a user is always displayed together with a shape-modified ultrasound image. This makes it possible for the user to recognize a positional relationship between the region of the image captured by the ultrasound imaging apparatus and the MRI cross-sectional image of interest. For example, in a case where a lesion area of interest is defined on the MRI image, a user may specify a MRI cross-sectional image of interest including the lesion area. In response, an image is displayed which allows the user to easily recognize the positional relationship between the lesion area and the ultrasound image.

### Modified Example 2-1

### Handling a Plurality of MRI Cross-Sectional Images of Interest

In the another embodiment described above, it is assumed by way of example that one cross-sectional image is selected by a user from an MRI image and an MRI cross-sectional image of interest is generated according to the selection. However, the MRI cross-sectional image of interest is not limited to this example. For example, alternatively, in a case where an MRI image includes a plurality of regions of lesion areas or the like, the cross-sectional image generation unit 1100 may generate a plurality of MRI cross-sectional image of interests including the respective regions of lesion areas in accordance with a command/information or the like given by the user. Note that the setting of the MRI cross-sectional image(s) of interest does not necessarily need to be performed directly according to setting specified by a user. For example, coordinates of a region of interest specified by a user are acquired, and three orthogonal cross sections including the specified region may be automatically set as the MRI cross-sectional images of interests. Still alternatively, for example, the image processing apparatus 700 according to the present embodiment may be connected to a not-shown image interpretation/report system such that information about a cross section of interest of an MRI image may be acquired from the image interpretation/report system, and a MRI cross-sectional image of interest may be generated based on the acquired information.

In a case where a plurality of MRI cross-sectional images of interest are generated, the display control unit 1080 may display all or part of the MRI cross-sectional images of interest. In a case where part of the MRI cross-sectional images of interest are displayed, a user may input a command/information or the like to specify one or more MRI cross-sectional images of interest. In response, displayed images may be changed. Still alternatively, for example, displayed images may be changed based on the positional relationship between the shape-modified ultrasound image and the MRI cross-sectional images of interest or based on positions of images with respect to the viewpoint.

As described above, the another embodiment provides a mechanism of displaying a cross-sectional image of interest (specified by a user) in a three-dimensional image and also displaying, together with it, a corresponding region corresponding to a cross-section region of an ultrasound image being captured for an object under examination. This makes it possible to easily compare a plurality of MRI cross-sectional images representing regions of lesion areas or the like of interest in the MRI image with an image-capturing region of the ultrasound image and an image being captured. Therefore, it is possible to clearly present to a medical doctor the relationship between the cross-sectional image(s) of interest and the region of the ultrasound image in the three-dimensional image.

In a case where a three-dimensional MRI image and a two-dimensional ultrasound tomographic image (ultrasound image) are in an identical or substantially identical state when being captured, the ultrasound tomographic image may be directly superimposed on the three-dimensional MRI image without calculating a conversion rule and without generating a shape-modified image, and a resultant superimposed image may be displayed.

In a case where there is a difference in deformed states, it may be allowed to display an ultrasound image modified in shape with reference to the three-dimensional MRI image and also display, in a parallel or switched manner, a three-dimensional MRI image modified in shape with reference to the ultrasound image.

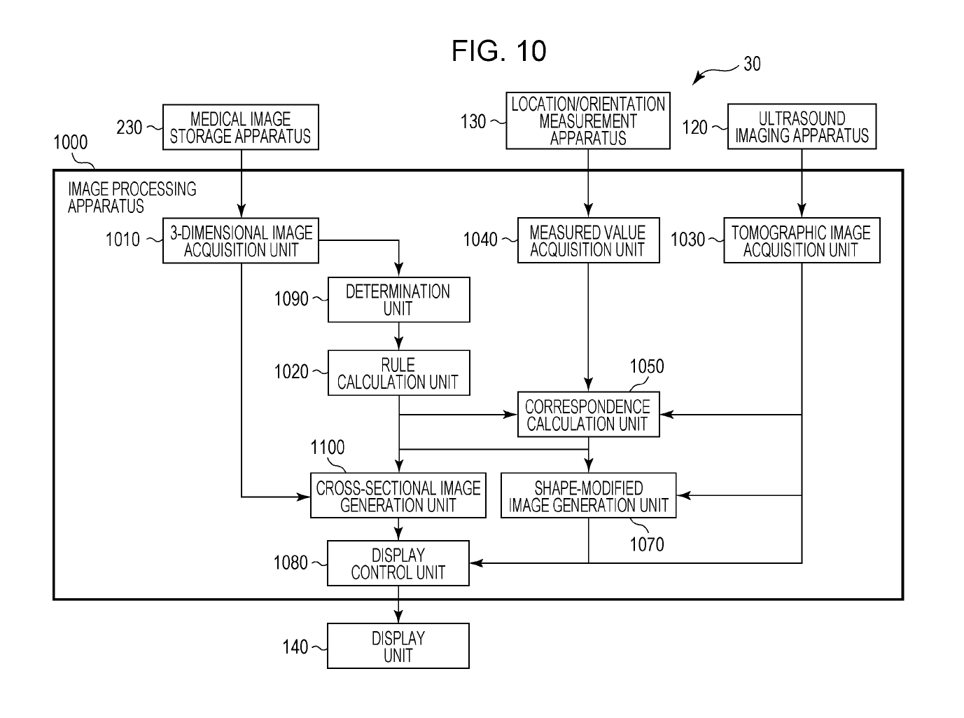

Referring to FIG. 10, a configuration of an image pickup system 30 and an associated processing flow according to the present embodiment are described below. A description is omitted in terms of similar parts/elements or similar processing steps to those in the previous embodiments.

The image pickup system 30 includes an ultrasound imaging apparatus 120 and an image processing apparatus 1000. Upon capturing an ultrasound image, a tomographic image acquisition unit 1030 acquires a tomographic image as required, and a display control unit 1080 displays the image on a display unit 140. A three-dimensional image acquisition unit 1010 acquires, from a medical image storage apparatus 230, a three-dimensional MRI image already captured for the same object under examination as that being subjected to taking the ultrasound image. Information about an image-capturing position of the three-dimensional MRI image is acquired as associated information of the three-dimensional MRI image.

A determination unit 1090 acquires a deformed state of the object under examination from the information about the image-capturing position of the three-dimensional MRI image. Note that the information about the image-capturing position may be directly used as the information indicating the deformed state. Furthermore, a deformed state of the object under examination is acquired based on an image-taking condition of the object under examination set in the ultrasound imaging apparatus 120. The determination unit 1090 compares the deformed states between the three-dimensional MRI image and the ultrasound tomographic image to determine whether there is a difference in deformed state. Also in a case where the deformed states are substantially equal, it is not determined that there is a difference. For example, even when there is a difference in image-capturing position as in a case where one image is captured in an upright position and another is captured in a sitting position, if the deformed states can be regarded as being substantially equal for a particular type of object under examination such as a breast or the like, it is not determined that there is a difference in deformed state.

In the above example, it is assumed by way of example that the determination is made as to whether there is a difference in deformed state. Alternatively, the determination may be performed in a different manner. For example, the determination may be performed as to whether deformed states are identical, or as to whether deformed states are identical or different.

In a case where it is not determined that there is a difference in deformed state, it is not performed to generate a shape-modified image for the three-dimensional MRI image and the ultrasound image. The correspondence calculation unit 1050 calculates the correspondence between the three-dimensional MRI image and the ultrasound image, and the images are displayed such that a two-dimensional ultrasound tomographic image is superimposed, at the calculated corresponding location, on the three-dimensional MRI image.

In a case where it is determined that there is a difference in deformed state, a ultrasound image is modified in shape with reference to the three-dimensional MRI image as in the previous embodiments described above. In accordance with a command issued by a user, a three-dimensional MRI image modified in shape with reference to the ultrasound image may be displayed in a parallel or switched manner.

In the following description, it is assumed by way of example that the three-dimensional MRI image is modified in shape and displayed.

The rule calculation unit 1020 calculates a conversion rule between different deformed states based on the three-dimensional MRI image. Alternatively, a conversion rule that is stored in advance in the medical image storage apparatus 230 may be employed. Instead of calculating the conversion rule based on the three-dimensional MRI image, an average conversion rule may be employed. In this case, the process is simplified.

The correspondence calculation unit 1050 modifies the shape of the MRI image based on the conversion rule and calculates the corresponding location of the image-capturing region of the two-dimensional ultrasound tomographic image. In the case of the two-dimensional ultrasound tomographic image, the image-capturing region is in a plane. The cross-sectional image generation unit 1100 generates an MRI cross-sectional image at a cross section corresponding to the image-capturing plane of the two-dimensional ultrasound tomographic image.

The display control unit 1080 displays the MRI cross-sectional image generated from the shape-modified three-dimensional MRI image and the unmodified two-dimensional ultrasound tomographic image on the display unit 140. They may be displayed in parallel or may be displayed such that the ultrasound tomographic image is superimposed on the MRI cross-sectional image to allow a user to easily recognize the correspondence between the images.

When a command issued by a user via a not-shown operation unit (a mouse 216, a keyboard 217, or the like) is received before or during the image displaying operation, the display control unit 1080 switches the display mode between a mode in which only the ultrasound image is modified in shape and a mode in which only the MRI image is modified in shape, or both images in accordance with the command.

Thus, in this embodiment, when the deformation of the object under examination is extremely large or when a user wants observation with reference to the ultrasound image, it is possible display the modified three-dimensional MRI image without modifying the shape of the ultrasound image thereby allowing the user to easily observe the object under examination.

In the case where there is no difference in deformed state, the images are displayed without being modified in shape and a correspondence is displayed. In the case where there is a difference in deformed state, the images are displayed such that one of the images is modified in shape and correspondence is displayed. Thus, an examiner such as a medical doctor or the like can easily understand the correspondence between the two types of images. When the object under examination is a breast, there is a difference in most cases in deformed state between the MRI image and the ultrasound image. On the other hand, there may not be a difference in deformed state in some types objects such as an abdomen. The present embodiment makes it possible to properly deal with images captured for different types of objects in a unified manner. Even in the case of taking images of the same breast, there is a possibility that there is or is not a difference in deformed state between the MRI image and the ultrasound image depending on the purpose or conditions of capturing the images, and the present embodiment allows it to properly deal with taking the images in a unified manner in any case.

In the case where there is a difference in deformed state between the MRI image and the ultrasound image, when one of images is modified in shape so as to be consistent with the other image, information may be provided to allow a user to recognize which image is modified in shape and which image is not modified. More specifically, for example, a text message, coloring, blinking, highlighting a frame border, or the like may be used as the information for the above purpose. In the case where there is no difference in deformed state, information may be displayed to indicate that both images are not modified in shape. In the system capable of displaying images in a plurality of different modes according to the present embodiment, presenting such information makes it possible for a user to easily understand properties of images being displayed, for example, in terms of what process has been performed on the images.

In the above-described system according to the present embodiment, the deformed state is determined, and the displaying of images is controlled such that the MRI image modified in shape and the ultrasound image modified in shape are displayed in a parallel or switched manner. Alternatively, the system may performed only one of the two processes, i.e., the deformation state determination process or the image display control process.

Embodiments of the image processing apparatus has been described above with reference to specific embodiments by way of example. However, the embodiments are not limited to these exemplary embodiments.

In the embodiments described above, it is assumed by way of example that the object under examination is a human breast. However, the embodiments may be applied to other types of objects.

In the embodiments described above, it is assumed by way of example that the three-dimensional image is an MRI image. However, the three-dimensional image may be other types of images. That is, the MRI apparatus 110 may be replaced, for example, by an X-ray CT apparatus, a photoacoustic tomography apparatus, a three-dimensional ultrasound imaging apparatus, or the like.

In the embodiments described above, it is assumed by way of example that when one of two images of an object is in a first deformed state while the other one of the two images is in a second deformed state, either one of the two images is modified in shape so as to be consistent with the other image. Alternatively, for example, to provide convenience to a user, both images may be modified in shape into a third deformed state different from the first and second deformed states. In this case, the rule calculation unit 1020 calculates a conversion rule for converting the first deformed state into the third deformed state and a conversion rule for converting the second deformed state into the third deformed state. The conversion rules may be calculated based on image information obtained by capturing a three-dimensional image of an object in a particular deformed state and also capturing three-dimensional images of the same object in the first, second, and third deformed states. The correspondence calculation unit 1050 calculates the correspondence between two images when the both are converted into the third deformed state. The corresponding-image generation unit 1060 and the shape-modified image generation unit 1070 respectively generate images in the third deformed state for the MRI image and the ultrasound image. These two shape-modified images are displayed under the control of the display control unit 1080. Thus, when a certain deformed state (the third deformed state) is defined as a reference state, even if two captured images are in other deformed states different from the third deformed state, it is possible to observe the two images in the reference deformed state in a unified manner.

In the embodiments described above, it is assumed by way of example that the ultrasound image is modified in shape and displayed. Alternatively, the ultrasound image in the before-deformation state may also be displayed in a parallel or switched manner. For example, in a case where the deformation of an object is so large that an ultrasound image is not good as an image for observing the object, the display control unit 1080 may display the ultrasound image in the before-deformation state on the display unit 140 in response to a command issued by a user. Thus, it is possible to display the correspondence between the MRI image and the ultrasound image in an easily understandable manner and it is possible to display the ultrasound image in an easily observable manner.

In the embodiments described above, it is assumed by way of example that both the MRI apparatus 110 and the ultrasound imaging apparatus 120 are connected to the image processing apparatus. Alternatively, for example, only the ultrasound imaging apparatus 120 may be connected as in the alternative embodiment, or only the MRI apparatus 110 may be connected. Still alternatively, no image pickup apparatus may be directly connected to the image processing apparatus, and images captured by image pickup apparatuses may be stored in the medical image storage apparatus 230 such that the image processing apparatus is allowed to acquire images from the medical image storage apparatus 230.

In the case where the three-dimensional MRI image and the two-dimensional ultrasound tomographic image are acquired from the medical image storage apparatus 230, the three-dimensional image acquisition unit 1010 and the tomographic image acquisition unit 1030 may be the same in functions and hardware configuration.

The features of the embodiments may also be achieved by providing, to an apparatus, a storage medium having program code stored thereon for implementing the functions disclosed in the embodiments described above and by reading and executing the program code on a computer (or a CPU or an MPU) disposed in the apparatus. In this case, the program code read from the storage medium implements the functions disclosed in the embodiments described above, and the storage medium on which the program code is stored falls within the scope of the embodiments of the present invention.

When the computer executes the program code read from the storage medium, a part or all of the process may be performed by an operating system or the like running on the computer. Such implementation of the functions also falls within the scope of the embodiments of the present invention.

Embodiments of the present invention include a storage medium in which the program code corresponding to the flow chart described above is stored.

Aspects of the embodiments of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present disclosure has been described with reference to exemplary embodiments, it is to be understood that the embodiments are not limited to the disclosed exemplary embodiments. The scope of the following claims is to be accorded the broadest interpretation so as to encompass all such modifications and equivalent structures and functions.

This application claims the benefit of Japanese Patent Application No. 2011-135353 filed Jun. 17, 2011, which is hereby incorporated by reference herein in its entirety.

What is claimed is:

1. An image processing apparatus configured to process an ultrasound image, comprising:
a three-dimensional image acquisition unit configured to acquire a three-dimensional image obtained by capturing an object that is in a first deformed state;
a tomographic image acquisition unit configured to acquire an ultrasound tomographic image obtained by capturing a particular cross section of the object that is in a second deformed state;
a generation unit configured to generate a curved cross section image corresponding to the ultrasound tomographic image in the first deformed state, based on a conversion rule between the first deformed state and the second deformed state; and
a display control unit configured to display the generated curved cross section image and the three-dimensional image in an aligned state on a display unit.

2. The image processing apparatus according to claim 1, further comprising a cross-sectional image generation unit configured to generate a cross-sectional image of the three-dimensional image at a cross section corresponding to an image-capturing plane of the tomographic image generated by the generation unit, wherein
the display control unit displays the corresponding region such that the corresponding region is superimposed on the generated cross-sectional image.

3. The image processing apparatus according to claim 2, wherein the display control unit displays the curved cross section image such that the curved cross section image is superimposed on the generated cross-sectional image of the three-dimensional image.

4. The image processing apparatus according to claim 1, further comprising a cross-sectional image generation unit configured to acquire a cross section of interest from the three-dimensional image, wherein
the display control unit displays the corresponding region and the cross section of interest such that a positional relationship therebetween is indicated.

5. The image processing apparatus according to claim 1, further comprising a determination unit configured to determine whether there is a difference in deformed state of the object under examination between the three-dimensional image and the tomographic image, wherein
the display control unit controls displaying such that when the determination unit determines that there is a difference in deformed state, a region corresponding to the curved cross section image is displayed on the display unit, while when the determination unit does not determine that there is a difference in deformed state, the ultrasound tomographic image is displayed on the display unit.

6. The image processing apparatus according to claim 1, wherein the display control unit controls displaying such that the image-capturing region is superimposed on a converted three-dimensional image obtained by converting the original three-dimensional image based on the conversion rule.

7. The image processing apparatus according to claim 1, further comprising a calculation unit configured to calculate the conversion rule based on the three-dimensional image.

8. The image processing apparatus according to claim 1, wherein
the tomographic image acquisition unit acquires a tomographic image captured by an ultrasound imaging apparatus connected to the image processing apparatus, and
the three-dimensional image acquisition unit acquires a three-dimensional image captured by at least one of a MRI apparatus and a CT apparatus connected to the image processing apparatus.

9. The image processing apparatus according to claim 1, wherein
the tomographic image acquisition unit acquires a tomographic image captured for an object under examination in a supine position, and
the three-dimensional image acquisition unit acquires a three-dimensional image captured for the object under examination in a prone position.

10. An image processing apparatus comprising:
an acquisition unit configured to acquire a two-dimensional ultrasound image in a supine position captured for an object under examination in the supine position;
an acquisition unit configured to acquire a three-dimensional image in a prone position captured for the object under examination in the prone position;
a calculation unit configured to calculate a conversion rule between the prone position and the supine position; and
a generation unit configured to generate a two-dimensional ultrasound image in the prone position from the two-dimensional ultrasound image in the supine position based on the conversion rule.

11. The image processing apparatus according to claim 10, further comprising a display control unit configured to display the generated two-dimensional ultrasound image in the prone position and the three-dimensional image in the prone position on a display unit.

12. An image pickup system comprising:
an image processing apparatus according to claim 1;
a display unit; and
an ultrasound imaging apparatus configured to capture the tomographic image.

13. An image processing method comprising:
acquiring a three-dimensional image captured for an object in a first deformed state;
acquiring an ultrasound tomographic image captured for a particular cross section of the object in a second deformed state;
generating a curved cross section image corresponding to the ultrasound tomographic image in the first deformed state, based on a conversion rule between the first deformed state and the second deformed state; and
displaying the generated curved cross section image and the three-dimensional image in an aligned state on a display unit.

14. A non-transitory computer readable medium storing a program configured to control a computer to execute a process including:
acquiring a three-dimensional image captured for an object in a first deformed state;
acquiring an ultrasound tomographic image captured for a particular cross section of the object in a second deformed state;
generating a curved cross section image corresponding to the ultrasound tomographic image in the first deformed state, based on a conversion rule between the first deformed state and the second deformed state; and
displaying the generated curved cross section image and the three-dimensional image in an aligned state on a display unit.
